(19) United States
(12) Patent Application Publication
(10) Pub. No.: US 2016/0110349 A1
(43) Pub. Date: Apr. 21, 2016

(54) Language Translating Device

(71) Applicant: Kimberly Norman-Rosedam, Stamford, CT (US)

(72) Inventor: Kimberly Norman-Rosedam, Stamford, CT (US)

(21) Appl. No.: 14/918,268

(22) Filed: Oct. 20, 2015

Related U.S. Application Data
(60) Provisional application No. 62/065,826, filed on Oct. 20, 2014.

(51) Int. Cl. G06F 17/28

(52) U.S. Cl. CPC G06F 17/289

(57) ABSTRACT

A language translating device is used to translate audible messages from a foreign language into the native language of the user. The language translating device includes an elongated housing, a microphone, a speaker, a control module, and a language translation module. Each of the electronic components of the language translating device is mounted within the elongated housing. The microphone is used to record the sound of a person speaking in a foreign language, a foreign film, or some other source of foreign dialog. The translation module translates the recording from the microphone and the speaker plays the translated message for the user to hear. The control module is responsible for regulating this process and the general operation of the language translating device. A portable power source is used to power the language translating device and a user input interface is used to adjust settings.

The current application claims a priority to the U.S. Provisional Patent application Ser. No. 62/065,826 filed on Oct. 20, 2014.

### FIELD OF THE INVENTION

The present invention relates generally to a device used for language translation. More specifically, the present invention is a portable language translator which may be placed in the ear and used to translate speech and media content from a foreign language to the native language of the user.

### BACKGROUND OF THE INVENTION

Language barriers can be a large obstacle in many situations. These include but are not limited to travel, watching foreign films or television, or simply carrying a conversation with a native speaker of a language other than one's own. Commonly used methods for translating foreign languages include using translation dictionaries, text translation applications, and voice to text translations. Some text translators also provide text-to-speech options. Each of these methods can be very useful but often require a considerable delay in order to translate a segment of speech or text. Specifically, text translators often require user input, which may be useful when studying a language, but can be cumbersome when attempting to hold a conversation with a foreign speaker. Speech to text translators partially solve this problem, but they are still not ideal during a direct conversation.

Accordingly, there is a present need for a device which may be used to accurately and quickly translate speech and audible media and play a translated message to the user in real time. The present invention is a language translating device which may be placed in a user's ear and used to translate speech, songs, movie dialog, and various other forms of media from a foreign language to a user's native language. The present invention also allows the user to record conversations to be played back and studied at a later time, thereby providing a useful tool when learning a foreign language.

### BRIEF DESCRIPTION OF THE DRAWINGS

FIG. 1 is a front left perspective view of the present invention.

FIG. 2 is a front right perspective view of the present invention.

FIG. 3 is a top cross-sectional schematic view of the present invention.

FIG. 4 is a schematic diagram showing the electronic connections of the present invention.

FIG. 5 is a schematic diagram showing the electrical connections of the present invention.

FIG. 6A is a schematic diagram showing the electronic connections of the user input interface.

FIG. 6B is a schematic diagram showing the electrical connections of the user input interface.

FIG. 7 is a front view of the present invention.

FIG. 8A is a cross-sectional view of the present invention taken about the line A-A in FIG. 7.

FIG. 8B is a cross-sectional view of the present invention taken about the line B-B in FIG. 7.

### DETAILED DESCRIPTION OF THE INVENTION

All illustrations of the drawings are for the purpose of describing selected versions of the present invention and are not intended to limit the scope of the present invention.

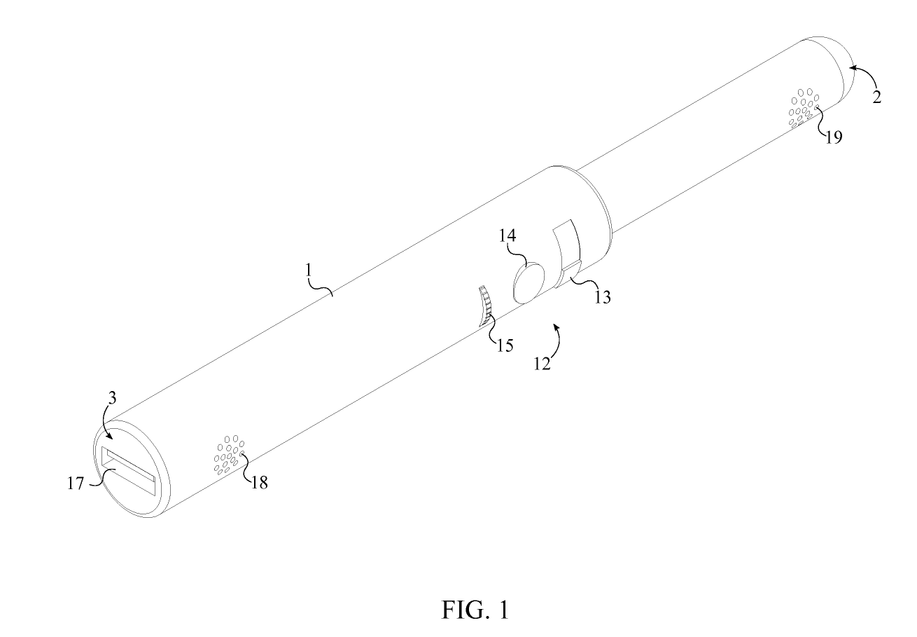

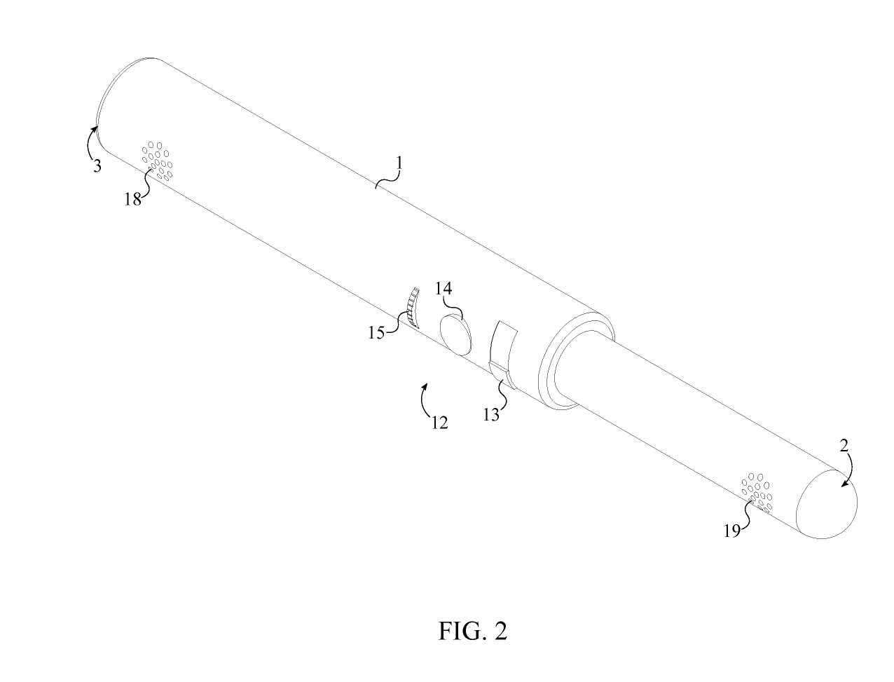

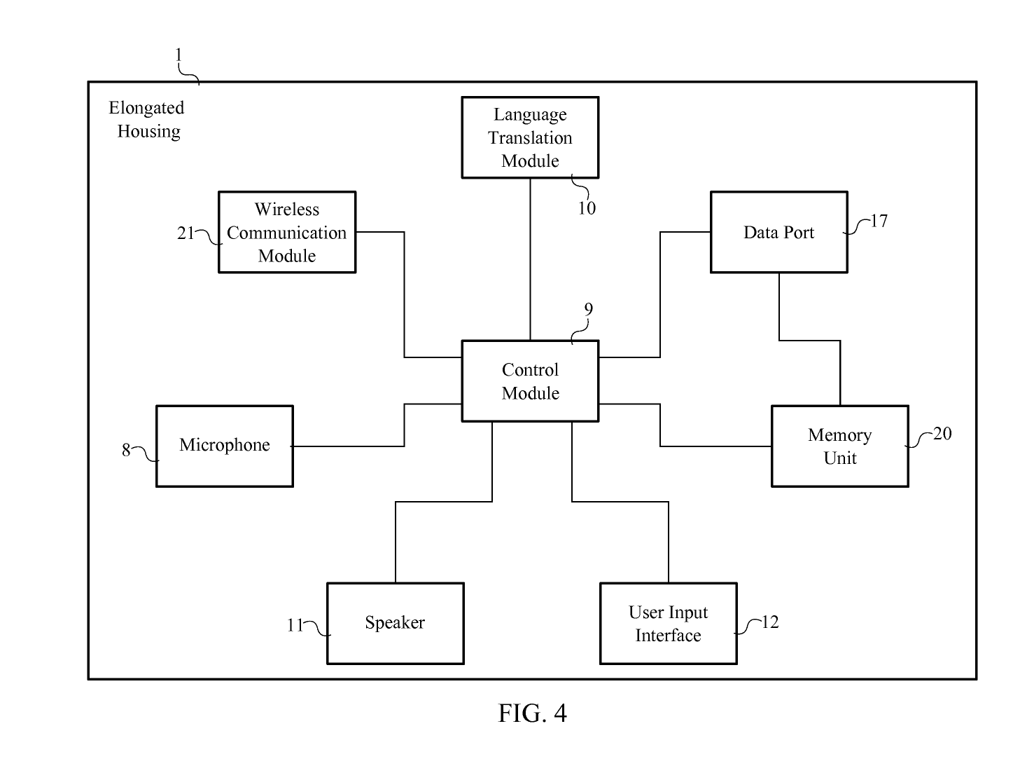

With reference to FIGS. 1-2, the present invention is a language translating device which may be placed inside the ear and used to translate human conversations, media dialog, and music from one language to another language. The present invention comprises an elongated housing 1, a microphone 8, a control module 9, a language translation module 10, a speaker 11, a user input interface 12, and a portable power source 16. The elongated housing 1 comprises a proximal end 2 and a distal end 3 so that the proximal end is positioned near the user's ear and the distal end is positioned offset from the user's ear. The proximal end 2 of the elongated housing 1 is designed to fit snugly into the user's ear. In the preferred embodiment of the present invention, the proximal end 2 of the elongated housing 1 is a dome-shaped end. This improves the safety of the present invention by limiting the chance that the user can damage or rupture their eardrum due to contact from the proximal end 2. The elongated housing 1 encloses all of the electrical components of the present invention. Thus the microphone 8, the language translation module 10, the speaker 11, the control module 9, and the portable power source 16 are mounted within the elongated housing 1. The control module 9 is used as a central hub for regulating all of the processes of the present invention. Consequently, the microphone 8, the language translation module 10, the speaker 11, and the user input interface 12 are electronically connected to the control module 9 as can be seen in FIG. 4.

The microphone 8 is used to capture sound of an audio message which may have originated from a person speaking or from music, movies, and other forms of media. The microphone 8 is positioned adjacent to the distal end 3 and is used to convert the audio message into a digital signal. The digital signal produced by the microphone 8 is received by the control module 9 and sent to the language translation module 10. The language translation module 10 is used to interpret the message represented by the digital signal.

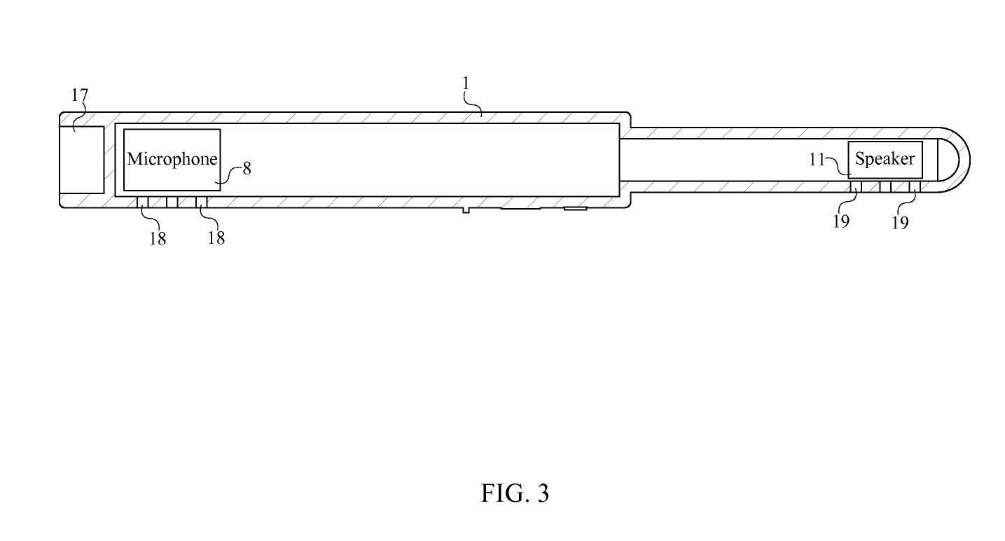

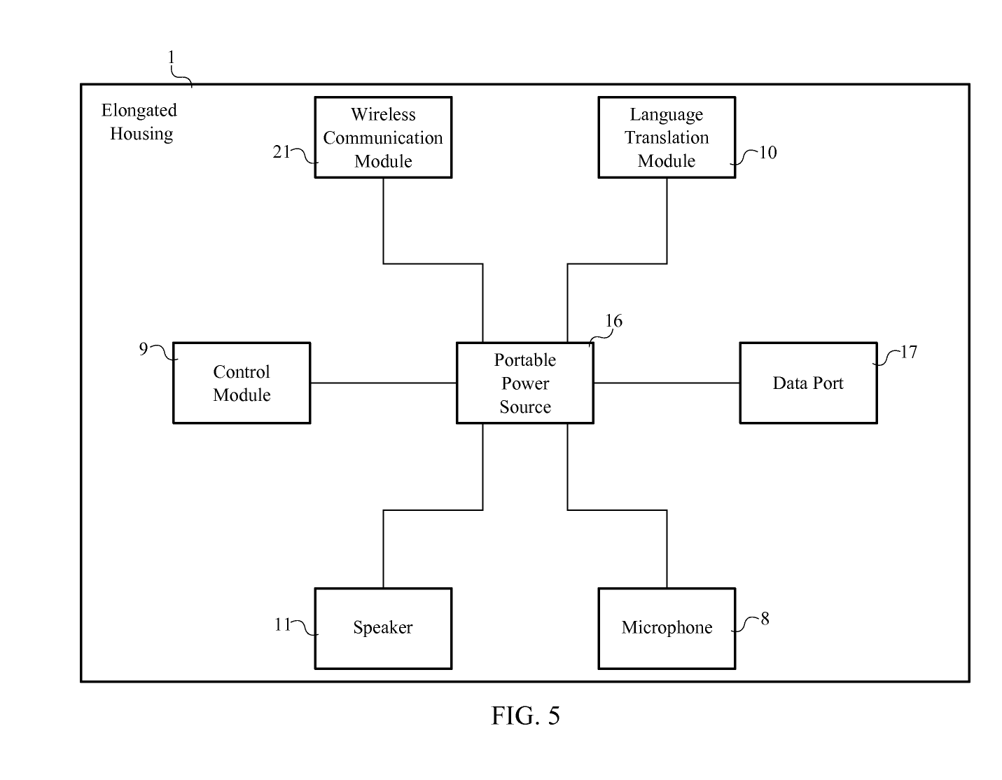

The language translation module 10 then translates the message and creates a translated digital signal that represents a translated version of the initial audio message. The control module 9 receives the translated digital signal from the language translation module 10 and sends the digital signal to the speaker 11. The speaker 11 is used to convert the translated digital signal into an audible translation which may be heard by the user. The speaker 11 is positioned adjacent to the proximal end 2 such that the sound produced by the speaker 11 is directed into the user's ear canal. The positioning of the microphone 8 and the speaker 11 is shown in FIG. 3 The microphone 8, the language translation module 10, the speaker 11, and the control module 9 each require electricity to function properly and are, therefore, electrically connected to the portable power source 16. This is shown in FIG. 5. In the preferred embodiment of the present invention, the portable power source 16 is a rechargeable battery; however, other types of portable power sources 16 may be used.

In reference to FIG. 1 and FIG. 4, the present invention further comprises a data port 17 which is used to transfer information between the language translating device and a computer. The data port 17 is mounted into the elongated housing 1 and is positioned adjacent to the distal end 3. In the preferred embodiment of the present invention, the data port 17 is a Universal Serial Bus (USB) port; however, various other types may be used. In reference to FIG. 5, the data port 17 is electrically connected to the portable power source 16. This allows the data port 17 to charge the portable power source 16. The data port 17 is electronically connected to the control module 9 and the language translation module 10. These connections allow the user to transfer language packs to the language translation module 10 or edit settings by communicating with the control module 9.

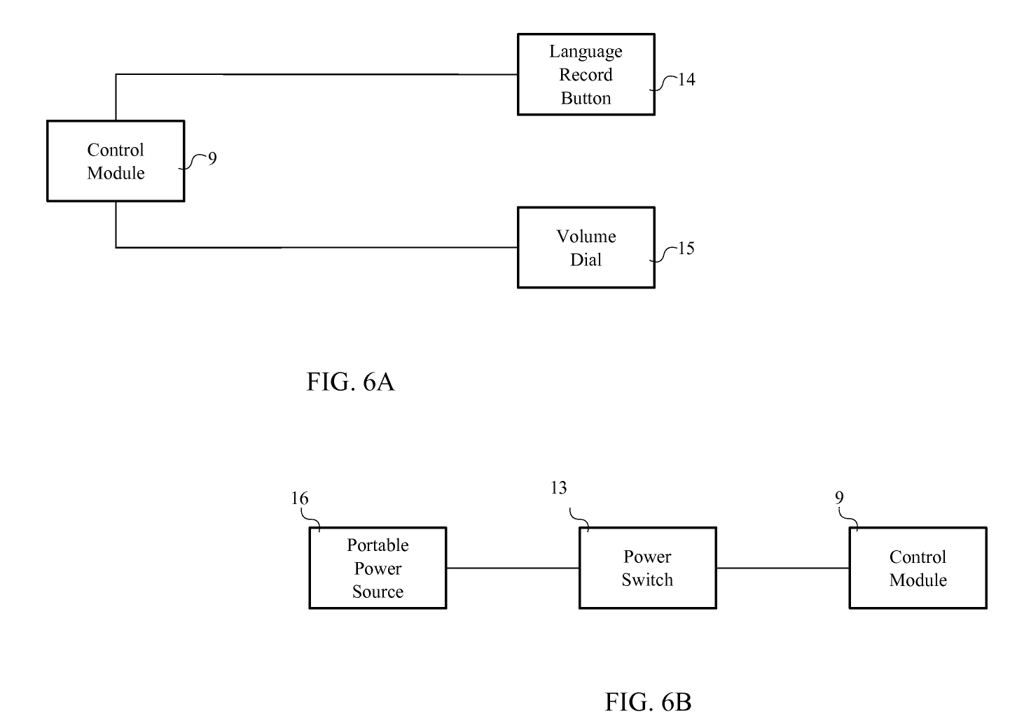

In reference to FIG. 1 and FIG. 6B, the user input interface 12 comprises a power switch 13. The power switch 13 is laterally mounted into the elongated housing 1 and is used to turn the language translating device on and off. The power switch 13 is electrically connected in between the portable power source 16 and the control module 9 such that the power switch 13 is able to regulate whether or not power is sent to the control module 9. Though the power switch 13 is a switch in the preferred embodiment, a button or any other mechanism may be used to turn the language translating device on or off.

In reference to FIGS. 1-3, the present invention further comprises a plurality of microphone holes 18 which is used to allow sound to reach the microphone 8 without being muffled by the elongated housing 1. Each of the plurality of microphone holes 18 laterally traverses into the elongated housing 1. The plurality of microphone holes 18 is laterally distributed around the elongated housing 1 and is positioned adjacent to the microphone 8. Positioning the plurality of microphone holes 18 adjacent to the microphone 8 provides a direct path for sound to reach the microphone 8.

Similar to the plurality of microphone holes 18, the present invention further comprises a plurality of speaker holes 19. The plurality of speaker holes 19 is used to allow sound to be emitted from the speaker 11 and through the user's ear canal without being muffled by the elongated housing 1. Each of the plurality of speaker holes 19 laterally traverses into the elongated housing 1. The plurality of speaker holes 19 is laterally distributed around the elongated housing 1 and is positioned adjacent to the speaker 11. Positioning the plurality of speaker holes 19 adjacent to the speaker 11 provides a direct path for sound to exit the elongated housing 1.

In reference to FIGS. 1, 6A, and 6B, the user input interface 12 comprises a language record button 14. The language record button 14 is laterally mounted into the elongated housing 1 and allows the user to record segments of a conversation or entire conversations. Having the ability to review a conversation can be very useful for someone who is trying to develop a better understanding of a foreign language. The present invention further comprises a memory unit 20 which is used to store the conversations recorded via the language record button 14. This is shown in FIG. 3. The memory unit 20 is mounted within the elongated housing 1. The memory unit 20 and the language record button 14 are electronically connected to the control module 9. When the user presses the language record button 14, the control module 9 directs the memory unit 20 to record the sound being picked up through the microphone 8. The data port 17 is electronically connected to the memory unit 20 such that after a conversation is recorded, the user may download the conversation from the memory unit 20 to a personal computer.

In reference to FIG. 2 and FIG. 4, the user input interface 12 further comprises a volume dial 15. The volume dial 15 is laterally mounted to the elongated housing 1 and is used to adjust the volume of the speaker 11. The volume dial 15 is electronically connected to the control module 9 such that when the volume dial 15 is turned, the control module 9 adjusts the volume of output for the speaker 11. Though the preferred embodiment of the present invention uses a dial, the volume dial 15 may alternatively be one or more buttons, a switch, or any other suitable mechanism.

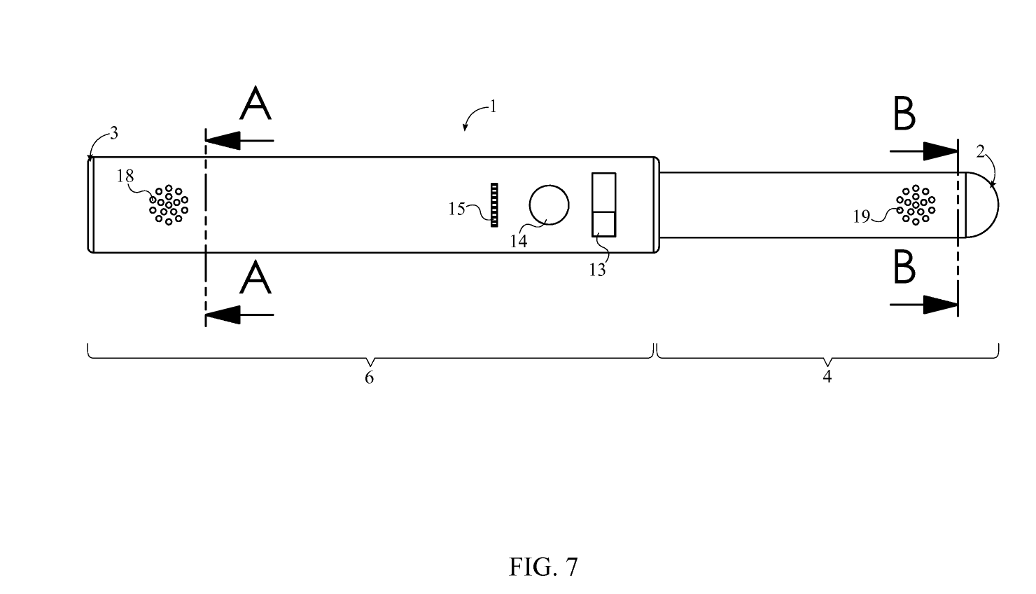

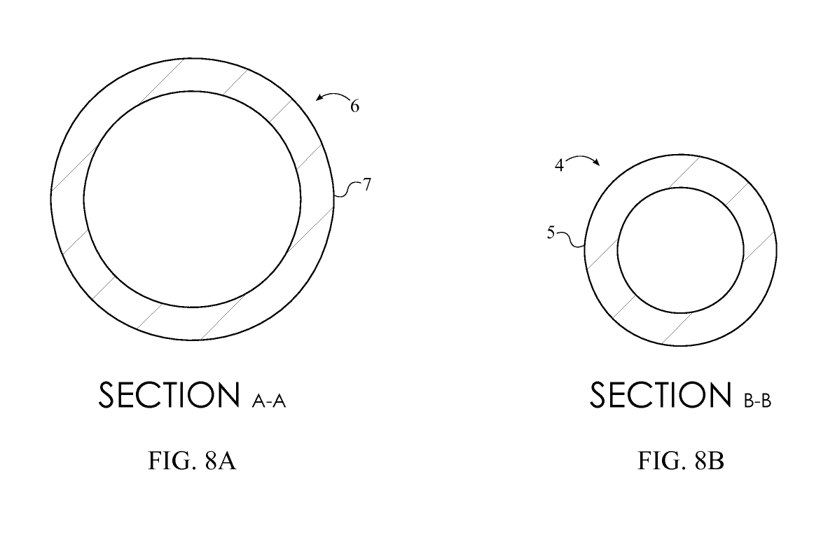

The elongated housing 1 comprises a first portion 4 and a second portion 6. The first portion 4 is positioned adjacent to the second portion 6 along the elongated housing 1. In the preferred embodiment of the present invention, the first portion 4 is flexible such that the first portion 4 may be bent or shaped to fit into the user's ear. The proximal end 2 is positioned adjacent to the first portion 4, opposite to the second portion 6. The first portion 4 and the second portion 6 are sized differently to provide a comfortable fit within the user's ear. In reference to FIGS. 7, 8A, and 8B, an outer cross-sectional perimeter 5 of the first portion 4 is smaller than an outer cross-sectional perimeter 7 of the second portion 6. This allows the first portion 4 to fit further into the user's ear canal and provide a direct path for sound to travel from the speaker 11 to the user's eardrum.

In reference to FIGS. 4-5, the present invention further comprises a wireless communication module 21. The wireless communication module 21 is mounted within the elongated housing 1 and is used to transfer data between the present invention and a computer, smartphone, or similar device. The wireless communication module 21 is electronically connected to the control module 9 and is electrically connected to the portable power source 16. In the preferred embodiment of the present invention, a mobile application may be used to transfer data to and from the language translating device or to edit settings. To do this, the control module 9 instructs the wireless communication module 21 to connect to an electronic device. Once a connection is established, information can be passed from the electronic device, through the wireless communication module 21, and to the control module 9.

Although the invention has been explained in relation to its preferred embodiment, it is to be understood that many other possible modifications and variations can be made without departing from the spirit and scope of the invention as hereinafter claimed.

What is claimed is:

1. A language translating device comprises:
an elongated housing;
a microphone;
a control module;
a language translation module;
a speaker;
a user input interface;
a portable power source;
the elongated housing comprises a proximal end and a distal end;
the microphone, the language translation module, the speaker, and the user input interface being electronically connected to the control module;
the microphone, the language translation module, the speaker, and the control module being electrically connected to the portable power source;
the microphone, the language translation module, the speaker, the control module, and the portable power source being mounted within the elongated housing;
the speaker being positioned adjacent to the proximal end; and
the microphone being positioned adjacent to the distal end.

2. The language translating device as claimed in claim 1 comprises:
a data port;
the data port being mounted into the elongated housing;
the data port being positioned adjacent to the distal end;
the data port being electrically connected to the portable power supply; and
the data port being electronically connected to the control module and the language translation module.

3. The language translating device as claimed in claim 1 comprises:
the user input interface comprises a power switch;
the power switch being laterally mounted into the elongated housing; and
the power switch being electrically connected in between the portable power source and the control module.

4. The language translating device as claimed in claim 1 comprises:
a plurality of microphone holes;
each of the plurality of microphone holes laterally traversing into the elongated housing;
the plurality of microphone holes being laterally distributed around the elongated housing; and
the plurality of microphone holes being positioned adjacent to the microphone.

5. The language translating device as claimed in claim 1 comprises:
a plurality of speaker holes;
each of the plurality of speaker holes laterally traversing into the elongated housing;
the plurality of speaker holes being laterally distributed around the elongated housing; and
the plurality of speaker holes being positioned adjacent to the speaker.

6. The language translating device as claimed in claim 1, wherein the proximal end is a dome-shaped end.

7. The language translating device as claimed in claim 1 comprises:
a memory unit;
the user input interface comprises a language record button;
the language record button being laterally mounted into the elongated housing;
the memory unit being mounted within the elongated housing; and
the memory unit and the language record button being electronically connected to the control module.

8. The language translating device as claimed in claim 7 comprises:
a data port; and
the data port being electronically connected to the memory unit.

9. The language translating device as claimed in claim 1 comprises:
the user input interface comprises a volume dial;
the volume dial being laterally mounted to the elongated housing; and
the volume dial being electronically connected to the control module.

10. The language translating device as claimed in claim 1 comprises:
the elongated housing comprises a first portion and a second portion;
the first portion being positioned adjacent to the second portion along the elongated housing;
the proximal end being positioned adjacent to the first portion, opposite to the second portion; and
an outer cross-sectional perimeter of the first portion being smaller than an outer cross-sectional perimeter of the second portion.

11. The language translating device as claimed in claim 1 comprises:
a wireless communication module;
the wireless communication module being mounted within the elongated housing;
the wireless communication module being electronically connected to the control module; and
the wireless communication module being electrically connected to the portable power source.

12. A language translating device comprises:
an elongated housing;
a microphone;
a control module;
a language translation module;
a speaker;
a user input interface;
a portable power source;
a data port;
the elongated housing comprises a proximal end and a distal end;
the microphone, the language translation module, the speaker, the user input interface, and the data port being electronically connected to the control module;
the microphone, the language translation module, the speaker, the control module, and the data port being electrically connected to the portable power source;
the data port being electronically connected to the language translation module;
the microphone, the language translation module, the speaker, the control module, and the portable power source being mounted within the elongated housing;
the speaker being positioned adjacent to the proximal end;
the microphone being positioned adjacent to the distal end;
the data port being mounted into the elongated housing; and
the data port being positioned adjacent to the distal end.

13. The language translating device as claimed in claim 12 comprises:
the user input interface comprises a power switch;
the power switch being laterally mounted into the elongated housing; and
the power switch being electrically connected in between the portable power source and the control module.

14. The language translating device as claimed in claim 12 comprises:
a plurality of microphone holes;
each of the plurality of microphone holes laterally traversing into the elongated housing;
the plurality of microphone holes being laterally distributed around the elongated housing; and
the plurality of microphone holes being positioned adjacent to the microphone.

15. The language translating device as claimed in claim 12 comprises:
a plurality of speaker holes;
each of the plurality of speaker holes laterally traversing into the elongated housing;
the plurality of speaker holes being laterally distributed around the elongated housing; and
the plurality of speaker holes being positioned adjacent to the speaker.

16. The language translating device as claimed in claim 12, wherein the proximal end is a dome-shaped end.

17. The language translating device as claimed in claim 12 comprises:
a memory unit;
the user input interface comprises a language record button;
the language record button being laterally mounted into the elongated housing;
the memory unit being mounted within the elongated housing;
the memory unit and the language record button being electronically connected to the control module; and
the memory unit being electronically connected to the data port.

18. The language translating device as claimed in claim 12 comprises:
the user input interface comprises a volume dial;
the volume dial being laterally mounted to the elongated housing; and
the volume dial being electronically connected to the control module.

19. The language translating device as claimed in claim 12 comprises:
the elongated housing comprises a first portion and a second portion;
the first portion being positioned adjacent to the second portion along the elongated housing;
the proximal end being positioned adjacent to the first portion, opposite to the second portion; and
an outer cross-sectional perimeter of the first portion being smaller than an outer cross-sectional perimeter of the second portion.

20. The language translating device as claimed in claim 12 comprises:
a wireless communication module;
the wireless communication module being mounted within the elongated housing;
the wireless communication module being electronically connected to the control module; and
the wireless communication module being electrically connected to the portable power source.
